(19) United States
(12) Patent Application Publication
(10) Pub. No.: US 2003/0102025 A1
(43) Pub. Date: Jun. 5, 2003

(54) Motorised gas control valve

(76) Inventor: Amrik Singh Garcha, Brierley Hill (GB)

Correspondence Address: BURNS, DOANE, SWECKER & MATHIS, L.L.P., P.O. Box 1404, Alexandria, VA, 22313-1404, US

(21) Appl. No.: 10/285,470

(22) Filed: Nov. 1, 2002

(30) Foreign Application Priority Data
Nov. 1, 2001 (GB) 0126279.9
Dec. 12, 2001 (GB) 0129678.9

(51) Int. Cl. F16K 11/10

(52) U.S. Cl. 137/66

(57) ABSTRACT

A control valve for a gas appliance comprising a gas valve body with a gas feed inlet, a first gas outlet for providing a gas supply to a pilot burner, a second gas outlet for providing a gas supply to an appliance main burner and valve means responsive to rotational movement of a spindle by an electric motor, whereupon rotational movement of the spindle opens the first gas outlet, and then further rotation produces axial movement of an associated rod member that opens or closes the second gas outlet.

### BACKGROUND OF THE INVENTION

This invention relates to a motorised gas control valve, and in particular a motorised control valve for a domestic or commercial gas appliance.

Conventional gas control valves as used on domestic gases fires and the like typically require a control knob mounted on a spindle to be first depressed and then rotated by a user. Thus, on depression of the knob gas is supplied to a pilot burner and ignited by a spark ignition system. Within a few seconds the pilot flame heats a thermocouple sufficiently to allow a magnet valve to be held open; such that gas will continue to flow to the pilot burner without the knob being depressed. The user then rotates the knob to ignite the main gas burner; and is able to vary the gas flowrate to the main burner by the degree of rotation. Such systems work well in many situations but do require a user to activate a knob or the like on the actual appliance. This means that this type of control is not suitable for remote operation; for example by a disabled user with a wireless controller or through a house-wide control system, for example a system controlled externally through a land line or radio link.

### SUMMARY OF INVENTION

An object of the present invention is to provide an improved gas control valve that overcomes at least some of these drawbacks. A further object is to provide a gas control valve system that can be operated remotely.

In one aspect the invention provides a control valve for a gas appliance comprising a gas valve body with a gas feed inlet, a first gas aperture or outlet for providing a gas supply to a pilot burner or a main burner for example, a second gas aperture or outlet for providing a gas supply to an appliance main burner and valve means responsive to axial and rotational movement of a spindle whereupon axial movement of the spindle opens, modulates or closes one gas outlet and rotational movement of the spindle opens, modulates or closes the other gas outlet, wherein both axial and rotational movement of the spindle is achieved by a single motor.

In another aspect the invention provides gas valve body with a gas feed inlet, a first gas aperture or outlet for providing a gas supply to a pilot burner, a second gas aperture or outlet for providing a gas supply to an appliance main burner and valve means responsive to rotational movement of a spindle where initial rotational movement of the spindle is translated into longitudinal motion of the spindle or an associated member which opens, modulates or closes one gas outlet and further rotational movement of the spindle opens, modulates or closes the other gas outlet, wherein the rotational movement of the spindle is provided by a single electric motor.

In yet another aspect the invention provides a gas valve body with a gas feed inlet, a first gas aperture or outlet for providing a gas supply to a pilot burner, a second gas aperture or outlet for providing a gas supply to an appliance main burner and valve means wherein axial movement of a spindle opens the first gas outlet and also varies the gas flowrate through the second gas outlet by changing the cross sectional area of an orifice between the gas inlet and the second gas outlet, the change in area being achieved by axial movement of a valve barrel relative to the valve body the said axial movement being as direct result of axial movement of the spindle; the said axial movement being provided by a single electric motor.

### BRIEF DESCRIPTION OF THE DRAWINGS

The invention will now be described by way of example only by reference to the following diagramatic figures in which:

FIG. 1 is a schematic diagram showing the main components of a valve according to a first embodiment of the invention,

FIG. 2 shows a side elevation of a valve according to a first embodiment,

FIG. 3 shows a typical relationship between axial spindle displacement (X) and angular rotation (α) of the spindle,

FIG. 4 shows various views of a niting plate according to the first embodiment of the invention,

FIG. 5 shows in schematic form the main components of a burner system using the valve of FIG. 1,

FIG. 6 is a sectioned elevation of the main components of a valve according to a second embodiment of the invention,

FIG. 7 is a plan view of the cam used in the second embodiment,

FIG. 8 is a side elevation corresponding to FIG. 7,

FIG. 9 shows the cam spindle (push rod) used in the second embodiment, and

FIG. 10 is a modified coupling between the motor and rest of the control valve according to a third embodiment of the invention.

### DETAILED DESCRIPTION OF THE INVENTION

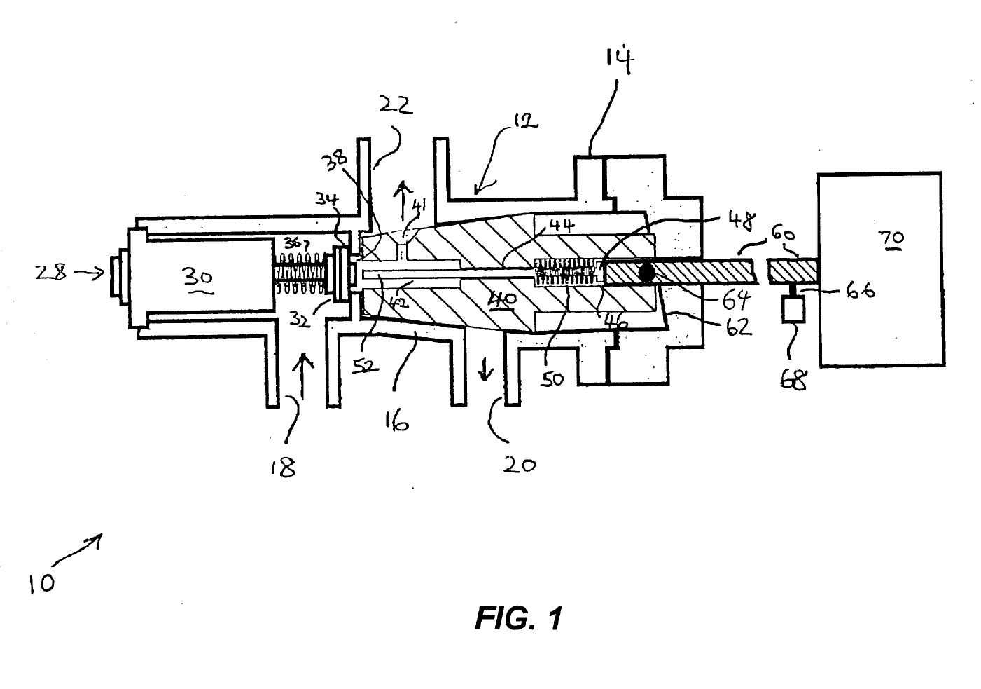

A first embodiment of the invention will now be described by reference to FIGS. 1 to 5. FIG. 1 is a schematic cross section of a motorised control valve, in the closed position, suitable for use as part of a domestic or commercial gas appliance; for example a gas fire. The control valve 10 comprises a main body 12 with a gas feed inlet 18, a pilot burner gas outlet 20 and a main burner gas outlet 22. Magnet valve 28, comprising electromagnet 30, piston 32, and a sealing ring 34 that sealingly engages an orifice 38 when the valve is in the closed position. This prevents gas flowing from the inlet duct of the valve to the outlet duct. The outlet duct of the valve has a frustro-conical shaped bore 16 adapted to accept a barrel or plug member 40. Barrel member 40 may rotate in a housing 14, and has an axial bore comprising three adjacent sections; a first section 42 nearest orifice 38, a second (intermediate) section 44 of smaller diameter, and a third section 46 at a cylindrical end of the barrel member 40. A push rod 52 can comprise a head portion 48 which closely fits within intermediate section 44 and carries a helical spring 50 that serves to bias the head portion 48 of the rod 52 against a first end of a spindle 60.

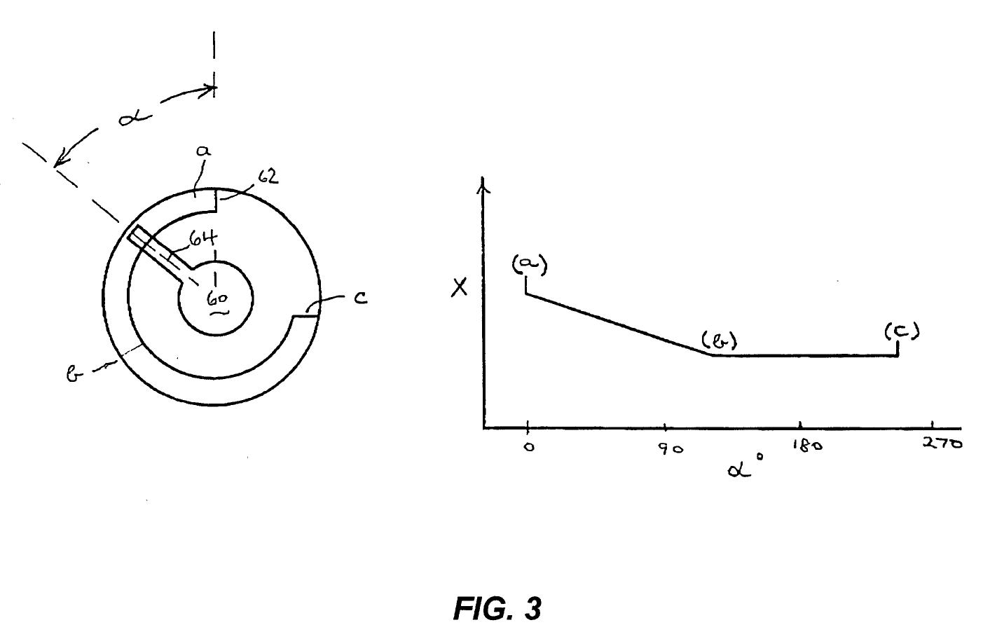

Spindle 60 has a short warded key or pin 64, located transversely to the spindle axis, that engages a single slot in the annular cylindrical end of barrel member 40. This allows barrel member 40 to be rotated in its seat by rotation of spindle 60. Pin 64 has a further important function; during operation of the valve (see latter) as spindle 60 is rotated pin 64 abuts against an inner annular surface of niting plate 62. This inner surface is ramped along at least part of its track so that upon rotation of the spindle 60 it is displaced in axial direction (X) to an extent that varies according to the angular rotation of the spindle (α). FIG. 3 shows in diagramatic form the abutment surface 62 formed on the inner face of niting plate 62, spindle 60 and pin 64 and shows a typical relationship between angular rotation (α) of the spindle and displacement (X) of the spindle.

Axial displacement of spindle 60 is transmitted to push rod 52 which slides axially along bore sections 42, 44 and 46 so that push rod 52 abuts against valve sealing ring 34, and hence opens magnet valve 28. Spindle extension member 64 may take various forms, for example a partial screw thread that engages a valve body member, such as the niting plate.

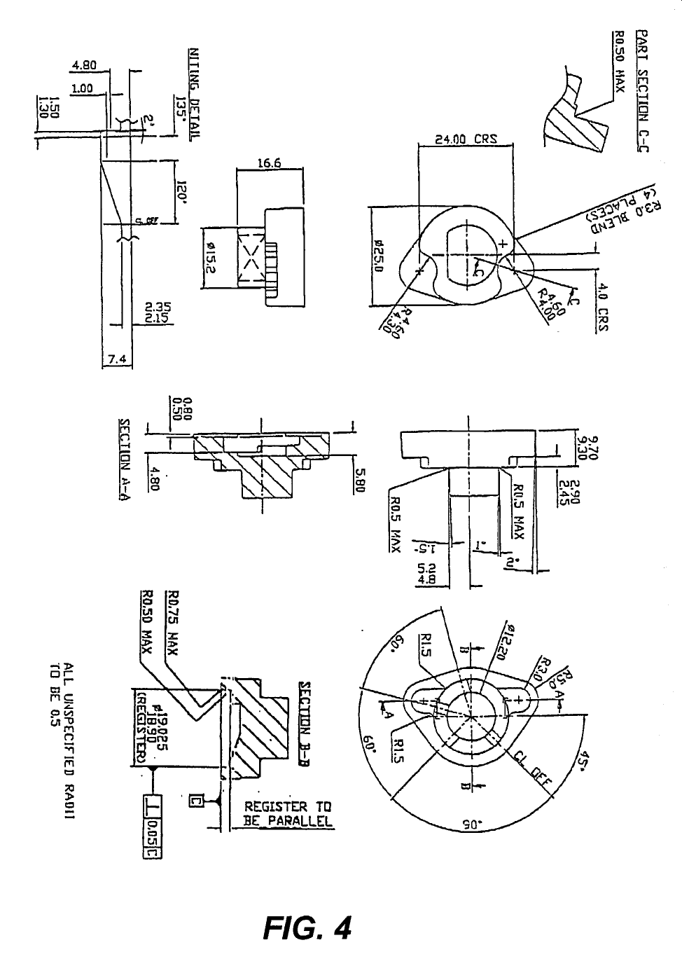

FIG. 4 shows in more detail a niting plate according to the first embodiment of the invention.

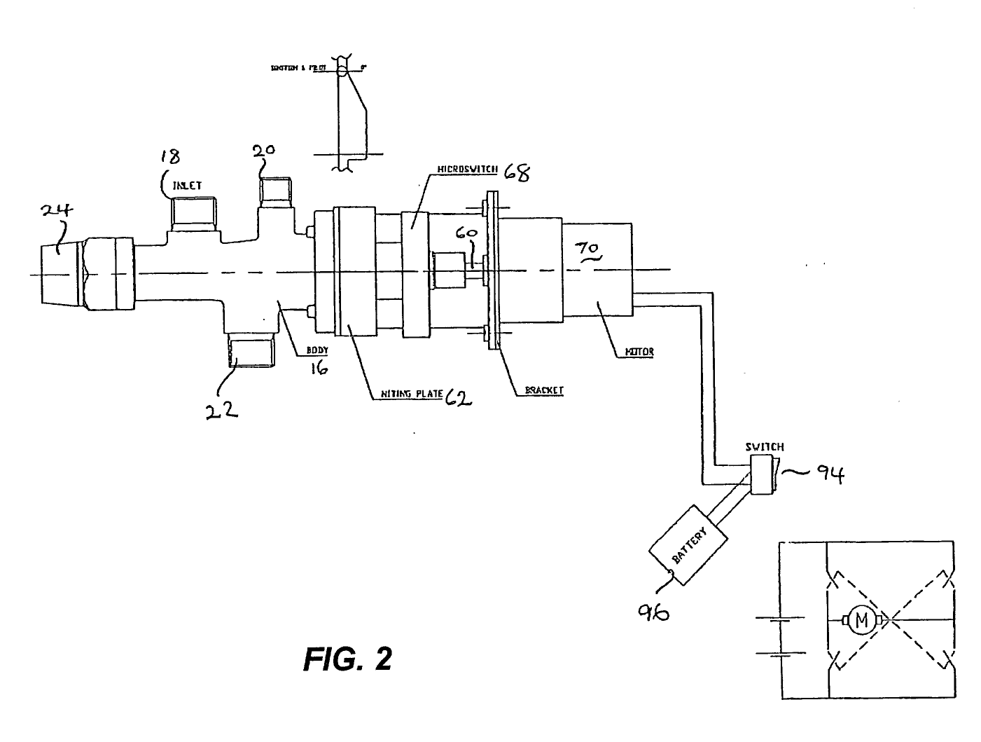

Spindle 60 is driven by a geared DC electric motor 70 powered by a battery 96 connected to the motor by a reversible polarity switch 94 of mechanical or electronic nature (see FIG. 2). The electric motor can be mains AC powered. The speed of the motor is reduced by a high ratio such as 900:1 using an integral gearbox (not shown). Shaft 60 also has a pin 66 or the like that at a predetermined position of rotation of spindle 60 causes a switch 68, attached to the valve, to be switched on or off.

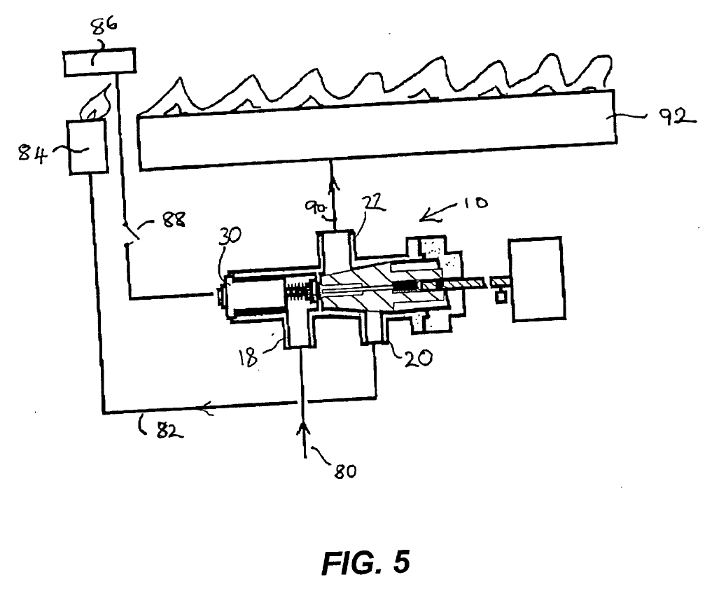

FIG. 5 shows the valve of the first embodiment in use as part of a burner system. A supply of natural gas 80 is fed to gas feed inlet 18 and gas from main burner gas outlet 22 is fed via pipe 90 to the main gas burner 92. Gas from the pilot burner gas outlet 20 is fed via pipe 82 to pilot burner 84. A pilot burner thermocouple 86 is connected to magnet switch 30 via an interrupter switch 88.

When a user of an appliance wishes to light the burner switch 94 is depressed to activate the motor and cause spindle 60 to rotate; thus rotating spindle 60 in a first direction; pin 64 abuts against the inner ramped surface of niting plate 64 and is thereby pushes spindle 60 and hence biased push rod 52 towards magnet valve 28. When push rod 52 abuts against the piston 32 of magnet valve 28 sealing ring 34 is pushed away from its seat against orifice 38 allowing gas to flow from gas feed inlet 18 to burner gas outlet 20 via orifice 34 and through a channel in the frustro-conical part of barrel 40 (not shown). At the same time rotation of the spindle causes switch 68 to close thereby starting a spark ignition system proximal the pilot burner. Thus, gas fed to the pilot burner is ignited and thermocouple 86 is heated. The current generated by the thermocouple is sufficiently large to energise an electromagnet in magnet valve 28 that then holds the magnet valve open without any contact force from push rod 52. At this point the pin 64 is at position (a) on the ramped surface of niting plate 64 (see FIG. 3). The direction of rotation of geared motor 70 is then reversed by switch 94 upwardly to reverse the direction of rotation of motor 70. Push rod 52 is thus progressively withdrawn from orifice 38 until pin 64 reaches point (b) on the ramped surface and thereafter progresses along level section between (b) and (c) during which the barrel member 40 continues to rotate first reaching a point where an orifice 41 in the barrel member 40 leading from axial bore 42 is presented adjacent burner gas outlet 22. A bore arrangement is used in barrel member 40 such that on further rotation of the barrel member 40 by motor 70 the size of the orifice is progressively increased so that when cross pin 64 reaches point (c) on the niting plate the valve is fully open and gas flows from gas feed inlet 18 to main burner gas output 22 via orifice 38, bore 42 and aperture 41. Meanwhile a gas flow path is also maintained between orifice 38 and outlet 20 to the pilot burner 84. Further rotation of the barrel can optionally result in flow to the main gas burner being shut off; this being achieved by an appropriately positioned blanking portion (that is a portion with no aperture 41) in the barrel.

Closing the valve is achieved by opening switch 88 or through rotation of the barrel member 40. Closing switch 88 prevents current from the thermocouple activating the magnet switch 30 which therefore closes and so prevents flow of gas through the valve body 12.

Preferably, means are provided (not shown) to allow spindle 60 to be manually rotated, to operate the valve, in the event of the motor 70 or its power supply etc., failing.

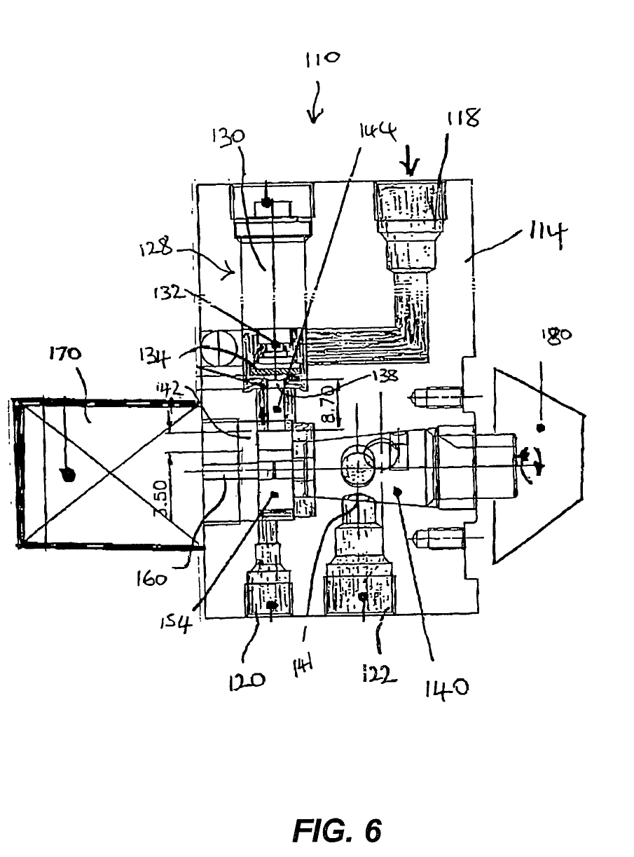

A second embodiment of the invention is shown in FIGS. 6 to 9. FIG. 6 is an elevation of a motorised control valve, in the closed position, suitable for use as part of a domestic or commercial gas appliance, for example a gas fire. The control valve 110 comprises a main body 114 with a gas feed inlet 118, a pilot burner gas outlet 120 and a main burner gas outlet 122. Magnet valve 128, comprising electromagnet 130, piston 132, and a sealing ring 134 that sealingly engages orifice 138 when the valve is in the closed position. This prevents gas flowing from the inlet duct of the valve to the outlet duct. The outlet duct of the valve has a frustro-conical shaped bore adapted to accept a barrel or plug member 140. A geared motor 170 drives a cam 154 via a spindle 160. When cam 154 is rotated by the motor 170 it moves an associated member 144, in this case a push rod, along a bore in the main body that may be at right angles to the axis of rotation of spindle 160, cam 154 and barrel member 140.

Initial rotation of cam 154 in a first direction by means of spindle 160 and motor 170 causes push rod 144 to abut against the piston 132 and sealing ring 134 of magnet valve 128 thereby opening this valve and allowing gas to flow from gas feed inlet 118 via orifice 138 and chamber 142 to pilot gas burner outlet 120. The generally cruciform cross section of push rod 144 (see FIG. 9) allows flow of gas through four quadrant channels formed between the push rod and the cylindrical bore within the main body 114 along which the rod slides. Again, initial rotation of spindle 160 activates a spark ignition system by means of a switch or the like. When the pilot burner has ignited current from a thermocouple activates magnet valve 128 so that it stays open without any force via push rod 144.

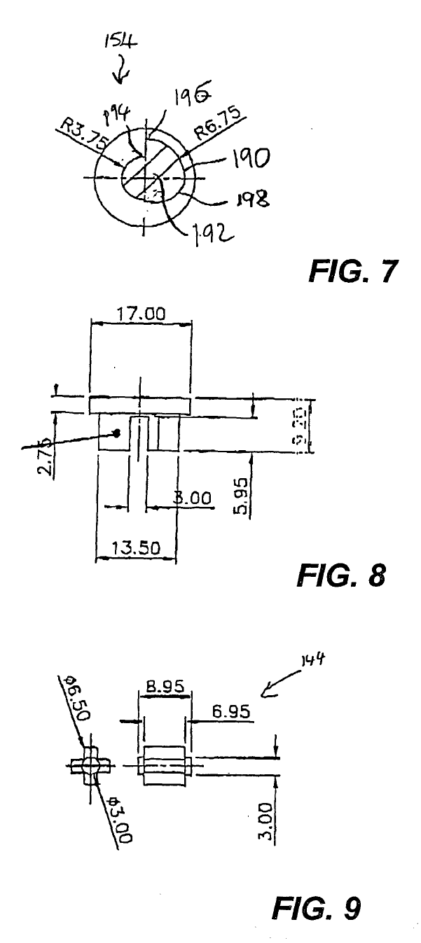

Rotation of motor 170 in the opposite direction then rotates barrel member 140 on its seat progressively through positions whereby an orifice of progressively increasing size (in the barrel member 140) is presented between chamber 142 and the main burner gas outlet 122. Hence, the flow of gas to the main burner may be continuously varied from a zero or low rate to maximum rate and held if desired at any intermediate rate. Barrel member 140 has a lip (not shown) that engages a corresponding slot 192 in the spindle (see FIGS. 7 and 8) so that rotation of spindle 160 causes a corresponding rotation of barrel member 140 in its seat.

The above arrangement conveniently allows a knob 180 to be fitted to the barrel member 140 at the end distant from the spindle 160. This has the further advantage that in the event of the motor 170 failing, for example owing to loss of power such as a flat battery, the valve may be operated manually in the traditional way, simply by turning knob 180 first in one direction to ignite the pilot burner and then in the opposite direction to set the flow of gas to the main burner. A clutch (see below) may optionally be provided to facilitate such manual operation of the valve.

FIGS. 7 and 8 show a plan view and side elevation respectively of the cam 154. Cam 154 comprises a circumferentially outer cam surface 190 on an axially protruding section 192. Cam surface 190 comprises, in this embodiment at least, a semi-circular surface portion 194, larger arcuate radius surface portion 196, and an intermediate spiral portion 198. The lip of the barrel (not shown) that engages slot 192 of the cam is dimensioned so that when engaged in the cam, semi-circular surface portion 194 of the cam, at least, presents a smooth continuous surface to push rod 144. It can be seen that during the first half turn of the cam 154 over surface 194, push rod 144 does not move, but does move towards sealing ring 134 during the rotation of cam 154 when push rod 144 is in abutment with the spiral portion 198 of the cam. Push rod 144 moves away from sealing ring 134 at the discontinuous interface between cam surface portions 196 and 194 as shown in FIG. 7.

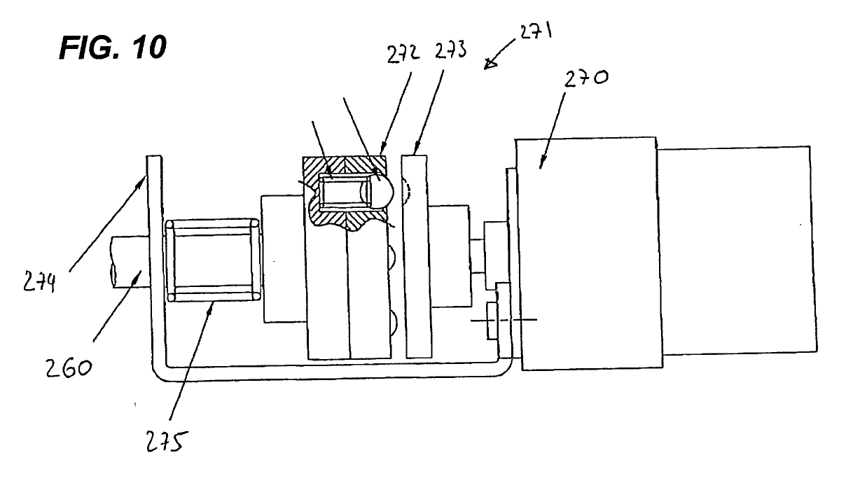

Referring to FIG. 10 there is shown a modification in the coupling between the motor and the rest of the control valve according to the invention. In this third embodiment, which can suitably form part of the earlier two embodiments, a motor 270 is coupled to a spindle 260 via a clutch 271. Spindle 260 can be the same as spindle 60 in relation to the first embodiment, or spindle 160 in relation to the second embodiment of the control valve according to the invention.

Clutch 271 comprises a first clutch plate 272 and a second clutch plate 273. In one form first clutch plate 272 carries a series of spring mounted ball bearings for engaging recesses in the second clutch plate 273 thereby to enable transfer of rotation from motor 270 to spindle 260. The first clutch plate 272 can be resiliently mounted in a mounting bracket 274 using a suitable resilient member such as a helical spring 275, in this case concentrically mounted on spindle 260. Spring 275 acts to push the first clutch plate 272 towards second clutch plate 273. A manual interface such as a simple tool can be used to engage first clutch plate 272 to enable manual separation of the first clutch plate 272 from second clutch plate 273 thereby to disengage the clutch and assist manual rotation of spindle 260.

Beneficially, the clutch enables the spindle 260 to be disengaged from the motor 270 thereby to enable manual operation of the control valve in spite of a high gearing ratio between the motor and the valve spindle which might otherwise prevent manual movement of the spindle.

In the arrangements described, rotation of plug or barrel member 40 and 140, and operation of the associated control valve 10 and 110 affect the following operations, ignition of a pilot or low rate burner, low burn, increasing burn, full burn, then an off position is achieved. However, modification of the barrel member is possible to enable alternative sequences in the operation. In one form, the operational steps are ignition, full burn, variable or intermediate burn, low burn and then off.

It will be appreciated that a significant benefit of use of the electrically driven spindle and cam arrangement according to the present invention is the ability remotely to control the operation of the control valve through control of the electric motor which effects, through the camming or ramped abutment surface arrangement, axial movement of a suitable push rod for effecting ignition of a burner as well as rotational movement of a barrel or plug member to effect variation in the rate of burn at a burner.

The electric motor 70, 170, 270 may be activated remotely using a hand held infrared controller, or for example by a land line link via a Personal Computer. The latter configuration opens the possibility of an appliance being switched on remotely via an Internet link. Preferably, the motor is controlled remotely by a hand held controller using conventional infra-red means, ultra sonic means or radio means that provide a control link between the hand controller and a suitable receiver that controls the power supply to the motor. Alternatively, the remote controller may simply be hard wired to the motor power supply actuator.

I claim:

1. A control valve for a gas appliance comprising a gas valve body with a gas feed inlet, a first gas outlet for providing a gas supply to a pilot burner, a second gas outlet for providing a gas supply to an appliance main burner and valve means responsive to axial and rotational movement of a spindle whereupon axial movement of the spindle opens or closes one gas outlet and rotational movement of the spindle opens or closes the other gas outlet, wherein both axial and rotational movement of the spindle is provided by a single electric motor.

2. A control valve according to claim 1 wherein axial movement of the spindle is produced through co-operation of the spindle or a spindle extension member and a valve body member as a result of rotation of spindle.

3. A control valve according to claim 2 wherein the spindle or spindle extension member co-operates with a ramped abutment surface of a valve body member.

4. A control valve according to claim 1 wherein axial movement of the spindle is produced entirely during a single turn of the spindle.

5. A control valve according to claim 4 wherein axial movement of the spindle only occurs during one third of a single turn of the spindle.

6. A control valve according to claim 3 wherein the abutment surface comprises a non-ramped section.

7. A control valve according to claim 3 wherein the abutment surface is part of or attached to a niting plate.

8. A control valve according to claim 2 wherein the spindle extension member is a transverse pin.

9. A control valve according to claim 1 wherein rotation movement of the spindle progressively varies the second gas outlet.

10. A control valve according to claim 1 wherein the spindle engages a barrel member for rotation therof.

11. A control valve according to claim 10 wherein during operation of the valve the cross sectional area of an orifice between the gas inlet and a gas outlet is varied this being achieved by rotational movement of the barrel member relative to the valve body.

12. A control valve according to claim 10 wherein during operation of the valve gas flow between the gas inlet and a gas outlet is prevented by rotational movement of the barrel member relative to the valve body.

13. A control valve according to claim 1 wherein axial movement of the spindle opens or closes the first gas outlet.

14. A control valve according to claim 1 wherein the first gas outlet comprises a magnet valve.

15. A control valve for a gas appliance comprising a gas valve body with a gas feed inlet, a first gas outlet for providing a gas supply to a pilot burner, a second gas outlet for providing a gas supply to an appliance main burner and valve means responsive to rotational movement of a spindle where initial rotational movement of the spindle is translated into longitudinal motion of the spindle or an associated member which opens or closes one gas outlet and further rotational movement of the spindle opens or closes the other gas outlet, wherein the rotational movement of the spindle is provided by a single electric motor.

16. A control valve according to claim 15 wherein the spindle comprises a cam member.

17. A control valve according to claim 16 wherein the cam member comprises a spiral abutment surface.

18. A control valve according to claim 16 wherein rotation of the cam causes axial movement of the associated member.

19. A control valve according to claim 18 wherein the axial movement is in a direction transverse to the axis of rotation of the spindle.

20. A control valve according to claim 15 wherein the spindle engages a barrel member for rotation thereof.

21. A control valve according to claim 20 wherein during operation of the valve the cross sectional area of an orifice between the gas inlet and a gas outlet is varied this being achieved by rotational movement of a barrel member relative to the valve body.

22. A control valve according to claim 20 wherein rotation of the barrel member progressively varies a gas outlet.

23. A control valve according to claim 21 wherein during operation of the valve gas flow between the gas inlet and a gas outlet is prevented by rotational movement of the barrel member relative to the valve body.

24. A control valve for a gas appliance comprising a gas valve body with a gas feed inlet, a first gas outlet for providing a gas supply to a pilot burner, a second gas outlet for providing a gas supply to an appliance main burner and valve means wherein axial movement of a spindle opens the first gas outlet and also varies the gas flowrate through the second gas outlet by changing the cross sectional area of an orifice between the gas inlet and the second gas outlet, the change in area being achieved by axial movement of a valve barrel relative to the valve body the said axial movement being as direct result of axial movement of the spindle; the said axial movement being provided by a single electric motor.

25. A control valve according to claim 1 wherein rotation of the spindle causes a switch, attached to the valve, to activate a burner spark ignition system.

26. A control valve according to claim 1 wherein a clutch is provided between the motor and the spindle to engage or disengage the motor from the spindle.

27. A control valve according to claim 1 wherein means are provided to allow the barrel member and/or spindle to be manually rotated to prevent flow of gas to a gas outlet.

28. A control valve according to claim 27 wherein the barrel member and/or spindle is rotated by no more than one full turn.

29. A control valve according to claim 1 wherein the electric motor is controlled remotely from the valve.

30. A control valve according to claim 29 wherein an external controller linked by infra-red means, ultra sonic means or radio means is used to control the motor.

31. A control valve according to claim 1 wherein the motor is battery powered.

32. A niting plate and spindle of a gas appliance control valve comprising a niting plate with a ramped abutment surface that co-operates with the spindle or an extension member thereof; such that the spindle may rotate relative to the niting plate and that during at least part of any such rotary movement the said co-operation produces axial movement of the spindle.

33. A niting plate and spindle according to claim 32 wherein the spindle or spindle extension member co-operates with generally helical abutment surface of a niting plate.

34. A control valve for a gas appliance comprising a gas valve body with a gas feed inlet, a first gas outlet for providing a gas supply to a pilot burner, a second gas outlet for providing a gas supply to an appliance main burner and valve means responsive to rotational movement of a spindle whereupon rotational movement of the spindle opens or closes one gas outlet, and then further rotation produces axial movement of an associated rod member that opens or closes the other gas outlet.
